(19) United States
(12) Patent Application Publication
(10) Pub. No.: US 2024/0166893 A1
(43) Pub. Date: May 23, 2024

(54) COATING COMPOSITION

(71) Applicant: Carboline Global Inc., Saint Louis, MO (US)

(72) Inventors: Steven Bockhold, Saint Louis, MO (US); John Kloepper, Saint Charles, MO (US)

(73) Assignee: Carboline Global Inc., Saint Louis, MO (US)

(21) Appl. No.: 18/512,832

(22) Filed: Nov. 17, 2023

Related U.S. Application Data
(60) Provisional application No. 63/427,241, filed on Nov. 22, 2022.

(51) Int. Cl. C09D 7/61; C08K 3/16; C09D 175/04

(52) U.S. Cl. CPC C09D 7/61; C08K 3/16; C09D 175/04

(57) ABSTRACT

A coating composition is provided. The coating composition includes a base coating composition and a chlorine indicating component. The coating composition is useful for forming a coating that can provide visual indicia of the presence of chlorine. Articles including such a coating are also provided.

### CROSS-REFERENCE TO RELATED APPLICATIONS

This application claims priority to and the benefit of U.S. Provisional Patent Application No. 63/427,241, filed Nov. 22, 2022, the entire contents of which is incorporated by reference herein.

### FIELD

The present disclosure relates to a coating composition. More particularly, the present disclosure relates to a coating composition for forming a coating that provides visual indicia of the presence of chlorine, as well as articles including such a coating.

### BACKGROUND

Chlorine (Cl₂) is one of the highest volume chemicals manufactured in the United States. As such, chlorine is also one of the most transported and stored chemicals in the United States. Major leaks from chlorine-containing storage tanks or railcars are readily visually apparent. However, minor leaks from chlorine-containing storage tanks or railcars may not be visually apparent at all. Indeed, such minor leaks may be overlooked and ignored until they develop into a more substantial leak that becomes visually apparent. Accordingly, there remains a need in the art for providing visual indicia of a chlorine leak from a chlorine-containing storage tank or railcar when such chlorine leak is not readily visually apparent.

### SUMMARY

Disclosed herein are coating compositions and articles including a coating formed from the coating compositions. The coating compositions are useful for forming a coating that can provide visual indicia of the presence of chlorine.

In accordance with the present disclosure, a coating composition is provided. The coating composition includes a base coating composition and a chlorine indicating component. When applied to a substrate and cured, the coating composition forms a coating that provides visual indicia of the presence of chlorine.

In accordance with the present disclosure, an article comprising a substrate and a coating disposed on the substrate is provided. The coating is formed from a coating composition comprising a base coating composition and a chlorine indicating component. The coating provides visual indicia of the presence of chlorine.

### DESCRIPTION OF THE DRAWINGS

FIG. 1 is a photograph illustrating an exposure chamber for exposing a substrate coated with an exemplary coating composition of the present disclosure to chlorine, as described in Examples 1 and 2;

FIG. 2 is a photograph illustrating visual indicia of chlorine exposure on the coated substrate of FIG. 1, according to Example 1;

FIG. 3 is a photograph illustrating the appearance of the coated substrate of FIG. 2 after conducting a solvent wipe to remove the visual indicia of chlorine exposure, according to Example 1;

FIG. 4 is a photograph illustrating the appearance of the coated substrate of FIG. 3 after further exposure to chlorine in the exposure chamber, according to Example 1;

FIG. 5 is a photograph illustrating visual indicia of chlorine exposure on four substrates coated with coating compositions of the present disclosure containing different amounts of chlorine indicating component, as described in Example 2;

FIG. 6 is a photograph illustrating the appearance of the Sample 2 coated substrate after conducting a solvent wipe to remove the visual indicia of chlorine exposure, according to Example 2; and

FIG. 7 is a photograph illustrating the appearance of the Sample 2 coated substrate of FIG. 6 after further exposure to chlorine in the exposure chamber, according to Example 2.

### DETAILED DESCRIPTION

Disclosed herein are coating compositions and articles including a coating formed from the coating compositions. While the present disclosure describes exemplary embodiments of the coating compositions and articles in detail, the present disclosure is not intended to be limited to the disclosed embodiments. Also, certain elements of exemplary embodiments disclosed herein are not limited to any exemplary embodiments, but instead apply to all embodiments of the present disclosure.

The terminology as set forth herein is for description of the embodiments only and should not be construed as limiting the disclosure as a whole. All references to singular characteristics or features of the present disclosure shall include the corresponding plural characteristic or feature, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The coating compositions and articles including a coating formed from a coating composition of the present disclosure can comprise, consist of, or consist essentially of the essential elements of the disclosure as described herein, as well as any additional or optional element described herein or which is otherwise useful in coating applications.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The coating composition according to the present disclosure includes a base coating composition and a chlorine indicating component. When applied to a substrate and cured, the coating composition forms a coating that provides visual indicia of the presence of chlorine. The term “chlorine,” as used herein, refers to elemental chlorine (i.e., Cl₂) or chemical compounds that can emit or otherwise release elemental chlorine (e.g., sodium hypochlorite, calcium hypochlorite).

Articles of the present disclosure include a substrate and a coating disposed on the substrate. The coating is formed from the coating composition disclosed herein.

As mentioned, after the coating composition is applied to a substrate and cured, the coating composition forms a coating that provides visual indicia of the presence of chlorine. In certain aspects, the visual indicia is a change of color of the coating. The change of color occurs when the coating is exposed to chlorine (e.g., chlorine gas or vapors). The chlorine reacts with or otherwise interacts with the chlorine indicating component (e.g., potassium iodide, potassium bromide) present in the coating and creates the visual indicia (i.e., change of color). In certain aspects, the coating composition is formulated to provide a coating having a first color (e.g., white) that when exposed to chlorine changes to a second color that contrasts with the first color (e.g., yellow/red).

The coating composition of the present disclosure provides an article, such as a railcar or a storage tank configured to hold chlorine, with a coating that readily provides visual indicia of a minor chlorine leak. Once aware of the minor leak via the visual indicia, remedial steps may be taken to ensure that the minor leak does not evolve into a more substantial leak.

As mentioned above, the coating composition of the present disclosure includes a base coating composition. The base coating composition may be formulated as a ready-to-use coating composition or as a two-part coating composition in which a first part and a second part are mixed to form the base coating composition.

The ready-to-use coating composition includes a resin (or binder) and a solvent. In certain aspects, the ready-to-use coating composition further includes a pigment. The ready-to-use coating composition may also include other additives utilized in conventional ready-to-use coating or paint compositions.

The resin is a polymer that provides adhesion to a substrate to which the coating composition is applied. The resin also forms a matrix to hold the pigment particles, if present, in place. Any conventional resin can be used in the ready-to-use coating composition of the present disclosure including, but not limited to, an acrylic resin, an alkyd resin, an epoxy resin, a vinyl resin, or a urethane resin. In certain aspects, the resin used in the ready-to-use coating composition comprises at least one of an acrylic resin, an alkyd resin, an epoxy resin, a vinyl resin, or a urethane resin.

The resin may be present in the coating composition (using a ready-to-use coating composition as the base coating composition) in an amount of, for example, 5 wt. % to 50 wt. %, including 10 wt. % to 40 wt. %, and also including 15 wt. % to 30 wt. %, based on the total weight of the coating composition.

The ready-to-use coating composition of the present disclosure includes a solvent. The solvent dissolves or disperses the components of the ready-to-use coating composition for application to the substrate, and also provides the ready-to-use coating composition with a desired viscosity for flow and ease of application. The solvent used in the ready-to-use coating composition may be one or more solvents compatible with the resin such as, for example, water, an organic solvent, or a combination of water and an organic solvent. Any conventional solvent may be used in the ready-to-use coating composition so long as it is compatible with the resin of the ready-to-use coating composition. In certain aspects, the solvent used in the ready-to-use coating composition comprises at least one of water or an organic solvent. Suitable organic solvents that may be used in the ready-to-use coating composition include, but are not limited to, hydrocarbons (e.g., hexane, benzene, xylene, mineral spirits, VM&P naphtha, toluene, petroleum distillates), alcohols (e.g., ethanol, n-propanol, isopropanol), ketones (e.g., acetone, methyl ethyl ketone, methyl isobutyl ketone, methyl n-amyl ketone, methyl isoamyl ketone), esters (e.g., ethyl acetate, butyl acetate, isopropyl acetate, glycol ether esters), and glycol ethers (e.g., ethylene glycol monobutyl ether (EGBE), dipropylene glycol monomethyl ether (DPGME), propylene glycol monomethyl ether (PGME)).

The solvent may be present in the coating composition (using a ready-to-use coating composition as the base coating composition) in an amount of, for example, 25 wt. % to 60 wt. %, including 30 wt. % to 55 wt., and also including 35 wt. % to 50 wt. %, based on the total weight of the coating composition.

The ready-to-use coating composition may include a pigment. The pigment can be used to impart the ready-to-use coating composition (and the resulting coating) with a desired color. Any conventional pigment can be used in the ready-to-use coating composition of the present disclosure. In certain aspects, the pigment used in the ready-to-use coating composition provides a white color. In certain aspects, the pigment comprises at least one of titanium dioxide, zinc oxide, alumina hydrate, lithopone, calcium carbonate, talc, or silica. Alternatively, the ready-to-use coating composition may be free of pigment such that the resulting coating is clear (or colorless/transparent).

When present, the pigment may be in the coating composition (using a ready-to-use coating composition as the base coating composition) in an amount of, for example, 5 wt. % to 50 wt. %, including 15 wt. % to 45 wt. %, and also including 20 wt. % to 40 wt. %, based on the total weight of the coating composition.

The ready-to-use coating composition may also include one or more additives that are typically used in conventional coating or paint compositions. Exemplary additives include, but are not limited to, extenders, emulsifiers, thickeners, stabilizers, texturizers, drying agents, UV absorbers, and biocides. The one or more additives may be present in the coating composition (using a ready-to-use coating composition as the base coating composition) in an amount of, for example, up to 20 wt. %, including 1 wt. % to 20 wt. %, including 2 wt. % to 18 wt. %, and also including 5 wt. % to 15 wt. %.

As mentioned above, the base coating composition may be formulated as a two-part coating composition. The two-part coating composition includes a first part comprising a resin and a second part comprising a curing agent for mixing with the first part to form the base coating composition. When a two-part coating composition is used as the base coating composition, the resulting coating composition may comprise from 50 wt. % to 100 wt. % solids, including from 60 wt. % to 100 wt. % solids, from 70 wt. % to 100 wt. % solids, from 80 wt. % to 100 wt. % solids, from 90 wt. % to 100 wt. % solids, from 95 wt. % to 100 wt. % solids, and also including from 98 wt. % to 100 wt. % solids. Those of skill in the art will appreciate that a coating composition having 100 wt. % solids does not contain a solvent.

In certain aspects, the resin of the first part of the two-part coating composition comprises at least one of an epoxy or a polyol. Any epoxy or polyol used in conventional two-part coating compositions can be used in the two-part coating composition of the present disclosure.

When the first part of the two-part coating composition includes an epoxy, the second part of the two-part coating composition includes a curing agent comprising at least one of an amine, a polymercaptan, a polyamide, an amidoamine, or a phenalkamine. The aforementioned types of curing agents (or hardeners) are well-known to those of ordinary skill in the art for reacting with the epoxy groups contained in the epoxy resin.

When the first part of the two-part coating composition includes a polyol, the second part of the two-part coating composition includes a curing agent comprising a polyisocyanate. In certain aspects, the polyol comprises at least one of an acrylic polyol, a polyester polyol, or a polyether polyol. The polyisocyanate can be aliphatic or aromatic. In certain aspects, the polyisocyanate comprises a diisocyanate (e.g., toluene diisocyanate, 1,5-naphthalene diisocyanate, methylene diphenyl diisocyanate, 4,4′-diisocyanato dicyclohexylmethane, hexamethylene diisocyanate, and isophorone diisocyanate). The aforementioned curing agents are well-known to those of ordinary skill in the art for reacting with the hydroxyl groups of the polyol resin.

A coating composition formed using a two-part coating composition as the base coating composition may include a resin in an amount of, for example, 5 wt. % to 65 wt. %, including 10 wt. % to 65 wt. %, 20 wt. % to 65 wt. %, 30 wt. % to 65 wt. %, 40 wt. % to 65 wt. %, and also including 50 wt. % to 65 wt. %, based on the total weight of the coating composition.

In certain aspects, the two-part coating composition may include a solvent. The solvent may be present in the first part, the second part, or both the first part and the second part of the two-part coating composition. In certain aspects, the solvent used in the two-part coating composition comprises at least one of water or an organic solvent (including any one or more of the organic solvents described with respect to the ready-to-use coating composition). The solvent may be present in the coating composition (using a two-part coating composition as the base coating composition) in an amount of, for example, up to 40 wt. %, including 5 wt. % to 30 wt., and also including 10 wt. % to 25 wt. %, based on the total weight of the coating composition. As previously mentioned, for a coating composition having 100 wt. % solids, no solvent is used in the two-part coating composition.

The two-part coating composition may include a pigment. The pigment may be present in the first part, the second part, or both the first part and the second part of the two-part coating composition. The pigment can be used to impart the two-part coating composition (and the resulting coating) with a desired color. Any conventional pigment can be used in the two-part coating composition of the present disclosure. In certain aspects, the pigment used in the two-part coating composition provides a white color. In certain aspects, the pigment comprises at least one of titanium dioxide, zinc oxide, alumina hydrate, lithopone, calcium carbonate, talc, or silica. Alternatively, the two-part coating composition may be free of pigment such that the resulting coating is clear (or colorless/transparent).

When present, the pigment may be in the coating composition (using a two-part coating composition as the base coating composition) in an amount of, for example, 0.5 wt. % to 50 wt. %. including 1 wt. % to 50 wt. %, 5 wt. % to 50 wt. %, 10 wt. % to 50 wt. %, 15 wt. % to 45 wt. %, and also including 20 wt. % to 40 wt. %, based on the total weight of the coating composition.

The two-part coating composition may also include one or more additives that are typically used in conventional two-part coating or paint compositions. The additives may be present in the first part, the second part, or both the first part and the second part of the two-part coating composition. Exemplary additives include, but are not limited to, extenders, emulsifiers, thickeners, stabilizers, texturizers, drying agents, UV absorbers, catalysts, and biocides. The one or more additives may be present in the coating composition (using a two-part coating composition as the base coating composition) in an amount of, for example, up to 20 wt. %, including 1 wt. % to 20 wt. %, including 2 wt. % to 18 wt. %, and also including 5 wt. % to 15 wt. %.

The coating composition of the present disclosure includes a chlorine indicating component. The chlorine indicating component is the functional ingredient in the coating composition (and the resulting coating) that reacts with or otherwise interacts with chlorine to provide visual indicia (i.e., change of color) of the presence of chlorine (e.g., chlorine vapors). Any compound that produces a change of color when exposed to chlorine can be used as the chlorine indicating component. Exemplary chlorine indicating components suitable for use in the coating composition of the present disclosure include, but are not limited to, iodide salts (e.g., potassium iodide, sodium iodide, calcium iodide) and bromide salts (e.g., potassium bromide, sodium bromide, calcium bromide). Iodide salts and bromide salts are both generally available in the form of a white or colorless crystalline powder that can be readily mixed with a base coating composition (i.e., a ready-to-use coating composition or a two-part coating composition).

The chlorine indicating component may be present in the coating composition in an amount of, for example, 0.05 wt. % to 10 wt. %, including 0.09 wt. % to 6 wt. %, and also including 0.09 wt. % to 3 wt. %, based on the total weight of the coating composition. In certain aspects, the chlorine indicating component used in the coating composition comprises an iodide salt (e.g., potassium iodide, sodium iodide, calcium iodide) and is present in the coating composition in an amount of 0.05 wt. % to 10 wt. %, including 0.1 wt. % to 6 wt. %, and also including 0.5 wt. % to 3 wt. %, based on the total weight of the coating composition. In certain aspects, the chlorine indicating component used in the coating composition comprises a bromide salt (e.g., potassium bromide, sodium bromide, calcium bromide) and is present in the coating composition in an amount of 0.05 wt. % to 10 wt. %, including 0.1 wt. % to 6 wt. %, and also including 0.5 wt. % to 3 wt. %, based on the total weight of the coating composition.

The coating composition of the present disclosure can be manufactured by mixing together the various components, namely, a resin, a solvent, one or more optional components such as a pigment or additives (i.e., the components of the ready-to-use base coating composition), and a chlorine indicating component, until a homogenous mixture is obtained. Alternatively, the coating composition can be prepared by an end user by adding a chlorine indicating component (e.g., potassium iodide, potassium bromide) to a premade ready-to-use base coating composition and mixing to form a homogenous mixture. The ready-to-use base coating composition can be any commercially available coating or paint composition that does not require further preparation (e.g., mixing with other compositions) prior to use.

In addition, the coating composition can be manufactured by preparing a two-part coating composition that includes a first part comprising a resin and a second part comprising a curing agent and adding a chlorine indicating component to the first part, the second part, or both the first part and the second part of the two-part coating composition. Prior to use, the first part and the second part are sufficiently mixed to form a homogenous mixture. Alternatively, the coating composition can be prepared by an end user by adding a chlorine indicating component to a premade first part or a premade second part of a two-part coating composition, or by adding a chlorine indicating component after or during the mixing of a premade first part and a premade second part of a two-part coating composition.

Exemplary coating compositions suitable for use as a base coating composition formulated as a ready-to-use coating composition include, but are not limited to, Carbocoat® 8215 alkyd enamel from Carboline Company (St. Louis, Missouri), Carbocoat® 75 alkyd enamel from Carboline Company (St. Louis, Missouri), and Valspar® StormCoat® acrylic exterior paint from The Valspar Corporation (Minneapolis, Minnesota). Exemplary coating compositions suitable for use as a base coating composition formulated as a two-part coating composition include, but are not limited to, Carboguard® 60 two-part epoxy coating available from Carboline Company (St. Louis, Missouri), Carboguard® 60 Tank White two-part epoxy coating available from Carboline Company (St. Louis, Missouri), Carboguard® 1340 WB waterborne two-part epoxy primer from Carboline Company (St. Louis, Missouri).

The coating composition may include from 90 wt. % to 99.95 wt. % of a base coating composition and from 0.05 wt. % to 10 wt. % of a chlorine indicating component, including from 94 wt. % to 99.9 wt. % of a base coating composition and from 0.1 wt. % to 6 wt. % of a chlorine indicating component, and also including from 97 wt. % to 99.5 wt. % of a base coating composition and from 0.5 wt. % to 3 wt. % of a chlorine indicating component, based on the total weight of the coating composition.

As mentioned above, articles of the present disclosure include a substrate and a coating disposed on the substrate. In certain aspects, the substrate comprises a metal (e.g., steel, aluminum). In certain aspects, the substrate comprises a steel material (e.g., carbon steel, stainless steel). In certain aspects, the substrate comprises a polymer material (e.g., polycarbonate, polyvinylchloride, polyethylene terephthalate).

The coating disposed on the substrate is formed from a coating composition disclosed herein. The coating composition can be applied to the substrate using any suitable technology or method conventionally used to apply coating compositions such as, for example, brushing, rolling, and spray coating (e.g., airless spray). Once applied to the substrate, the coating composition is allowed to cure (or otherwise dry or solidify) to form a coating. The thickness of the coating composition applied as well as the surface temperature of the substrate will affect the curing time. Generally, the coating composition will cure (or otherwise dry or solidify) within 30 minutes to 48 hours at substrate surface temperatures of 4° C.to 32° C. In certain aspects, the coating composition is allowed to cure (or otherwise dry or solidify) at ambient temperatures (e.g., about 4° C.to about 49° C.). Although not required, curing (or otherwise drying or solidifying) of the coating composition may be accelerated by increasing the temperature of the surrounding environment to which the applied coating composition is exposed.

In certain aspects, the substrate can include a layer of primer or adhesion promoter. The coating composition can be applied to the optional layer of primer or adhesion promoter using any of the application techniques mentioned above. The optional layer of primer or adhesion promoter can be used to create a stronger adhesion between the coating and the substrate.

Articles of the present disclosure are generally configured to retain or otherwise store chlorine. Examples of the article include, but are not limited to, a storage cylinder for storing chlorine, a storage tank for storing chlorine, and a railcar for storing and transporting chlorine. Accordingly, a coating including a chlorine indicating component disposed on an exterior surface of the substrate of the article will provide visual indicia should chlorine begin to leak from the article.

### EXAMPLES

The following examples illustrate exemplary embodiments of coating compositions described herein. The examples are given solely for the purpose of illustration and are not to be construed as limiting of the present disclosure, as many variations thereof are possible without departing from the spirit and scope of the present disclosure.

Example 1: A coating composition was prepared by thoroughly mixing 1.25 grams of potassium iodide (particle size of ≤ 53 microns) with 18.79 grams of Carboguard® 60 White Part A coating component from Carboline Company (St. Louis, Missouri), thereby forming a first mixture. The first mixture was then mixed with 22.75 grams of Carboguard® 60 Part B coating component from Carboline Company (St. Louis, Missouri), thereby forming the coating composition.

The coating composition was then applied to a primed steel plate using a foam brush. The coating composition was allowed to cure at room temperature (e.g., 20° C. to 25° C.) for 10 days and formed a white-colored coating on the steel plate.

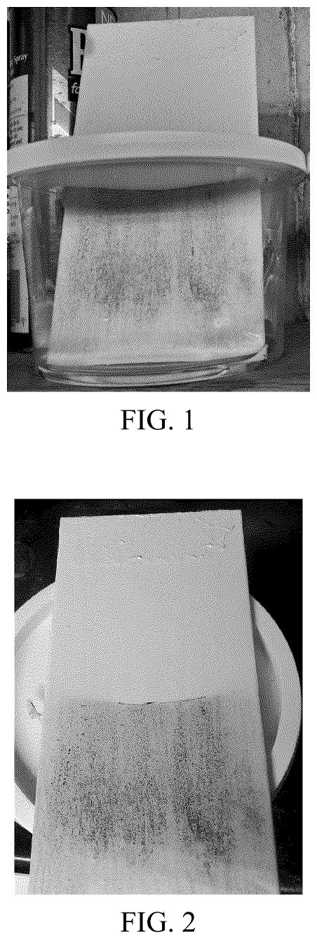

A portion of the coated steel plate was then placed in an exposure chamber containing a small amount of bleach, as seen in FIG. 1. The exposure chamber consisted of a clear plastic container having a lid with a slot sized to receive the coated steel plate. After 3 hours of exposure in the exposure chamber, the white-colored coating of the exposed portion of the coated steel plate turned a yellowish-red color, as seen in FIG. 2.

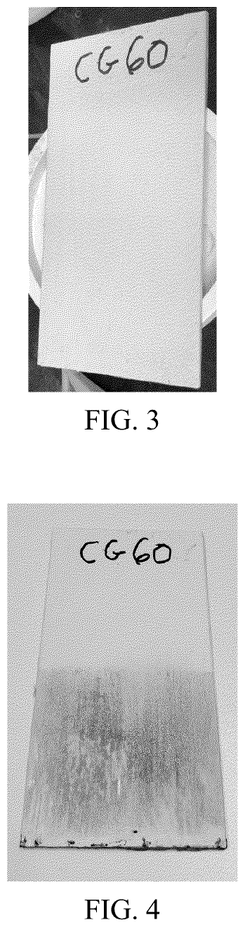

The coated steel plate was then removed from the exposure chamber and rinsed with water. No visible change was observed after the water rinse. The coated steel plate was then wiped with methyl ethyl ketone (MEK), which left a dull yellow hue on the portion of the coated steel plate that had been in the exposure chamber, as seen in FIG. 3. The MEK-wiped coated steel plate was then placed into the exposure chamber and a similar change in color as initially occurred was observed, as seen in FIG. 4.

Example 2: Coating compositions were prepared by combining 500 grams of solid potassium iodide with 1 gallon of Carboguard® 60 White Part A coating component from Carboline Company (St. Louis, Missouri) using a basket mill, thereby forming a first mixture. Portions of the first mixture were then mixed with an amount of Carboguard® 60 White Part A coating component from Carboline Company (St. Louis, Missouri) to create four different second mixtures that included different amounts of potassium iodide. Each of the second mixtures were then mixed with an amount of Carboguard® 60 Part B coating component from Carboline Company (St. Louis, Missouri), thereby forming four coating compositions (i.e., Sample 1 (864-183-1), Sample 2 (864-183-2), Sample 3 (864-183-3), and Sample 4 (864-183-4)) having different amounts of potassium iodide, as shown in Table 1 below.

TABLE 1
Potassium Iodide Loading Levels

| | Potassium Iodide (wt. %*) |
|---|---|
| SAMPLES | in Coating Composition |
| Sample 1 (864-183-1) | 4.2 |
| Sample 2 (864-183-2) | 3.2 |
| Sample 3 (864-183-3) | 2.2 |
| Sample 4 (864-183-4) | 1.1 |

*Based on the total weight of the coating composition.

Each coating composition was then applied to a different primed steel plate using a foam brush. The coating compositions were allowed to cure at room temperature (e.g., 20° C.to 25° C.) for 2 days and each coating composition formed a white-colored coating on the respective primed steel plate.

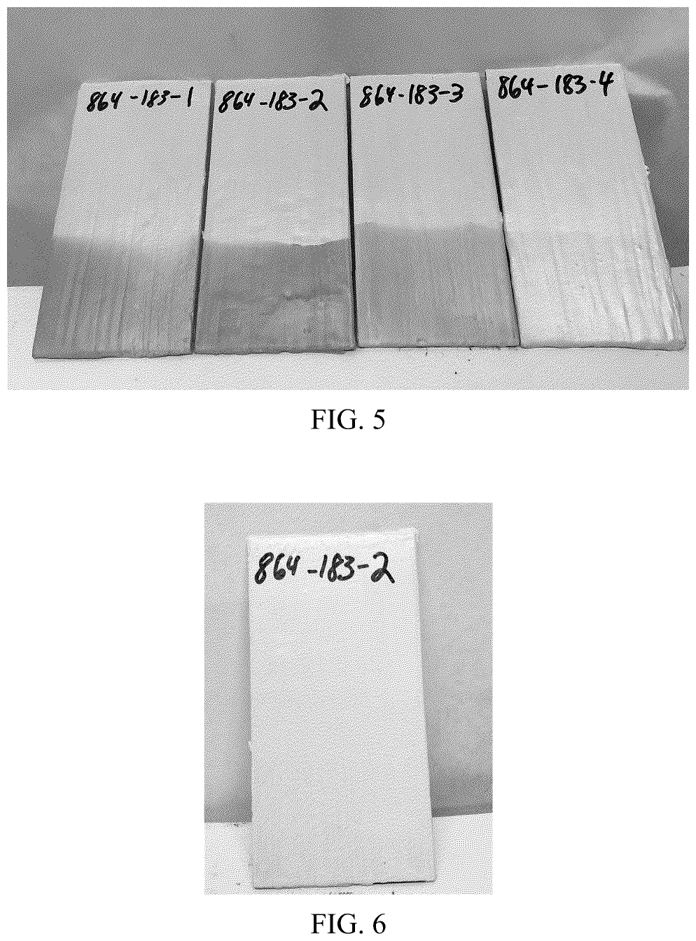

A portion of each coated steel plate was then placed in an exposure chamber containing a small amount of bleach. The exposure chamber consisted of a clear plastic container having a lid with a slot sized to receive the coated steel plate. After 3 hours of exposure in the exposure chamber, the white-colored coating of the exposed portion of each coated steel plate turned a yellowish-red color with differing intensity (dependent on potassium iodide loading level), as shown in FIG. 5.

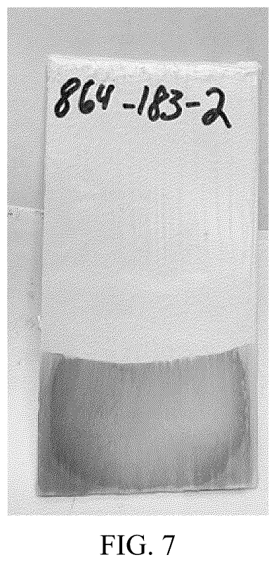

Each of the coated steel plates were subsequently removed from the exposure chamber and rinsed with water. No visible changes were observed after the water rinse. Each coated steel plate was then wiped with methyl ethyl ketone (MEK), which left a dull yellow hue on the portion of each coated steel plate that had been in the exposure chamber, as shown in FIG. 6 for Sample 2 (864-183-2) only. Each MEK-wiped coated steel plate was then placed into the exposure chamber and similar changes in color as initially occurred were observed, as shown in FIG. 7 for Sample 2 (864-183-2) only.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the present disclosure, in its broader aspects, is not limited to the specific details, the representative compositions and processes, and illustrative examples shown and described. Accordingly, departures may be made from such details without departing from the spirit or scope of the present disclosure.

1. A coating composition comprising:
a base coating composition; and
a chlorine indicating component.

2. The coating composition according to claim 1, wherein the base coating composition is a ready-to-use coating composition comprising a resin and a solvent.

3. The coating composition according to claim 2, wherein the ready-to-use coating composition further comprises a pigment.

4. The coating composition according to claim 2, wherein the solvent comprises at least one of water or an organic solvent.

5. The coating composition according to claim 2, wherein the resin comprises at least one of an acrylic resin, an alkyd resin, an epoxy resin, a vinyl resin, or a urethane resin.

6. The coating composition according to claim 1, wherein the base coating composition is a two-part coating composition comprising:
a first part comprising a resin; and
a second part comprising a curing agent for mixing with the first part to form the base coating composition,
wherein the chlorine indicating component is dispersed in at least one of the first part or the second part.

7. The coating composition according to claim 6, wherein the coating composition comprises from 50 wt. % to 100 wt. % solids.

8. The coating composition according to claim 6, wherein the resin comprises at least one of an epoxy or a polyol,
wherein when the resin comprises an epoxy, the curing agent comprises at least one of an amine, a polymercaptan, a polyamide, an amidoamine, or a phenalkamine, and
wherein when the resin comprises a polyol, the curing agent comprises a polyisocyanate.

9. The coating composition according to claim 1, wherein the chlorine indicating component comprises at least one of an iodide salt or a bromide salt.

10. The coating composition according to claim 9, wherein the iodide salt comprises at least one of potassium iodide, sodium iodide, or calcium iodide, and wherein the bromide salt comprises at least one of potassium bromide, sodium bromide, or calcium bromide.

11. The coating composition according to claim 1, wherein the coating composition comprises from 0.05 wt. % to 10 wt. % chlorine indicating component, based on the total weight of the coating composition.

12. The coating composition according to claim 1, wherein the coating composition comprises from 0.1 wt. % to 6 wt. % chlorine indicating component, based on the total weight of the coating composition.

13. The coating composition according to claim 1, wherein the coating composition comprises from 0.5 wt. % to 3 wt. % chlorine indicating component, based on the total weight of the coating composition.

14. The coating composition according to claim 1, wherein when applied to a substrate and cured, the coating composition forms a coating that provides visual indicia of the presence of chlorine.

15. An article comprising:
a substrate; and
a coating disposed on the substrate,
wherein the coating is formed from a coating composition comprising a base coating composition and a chlorine indicating component, and
wherein the coating provides visual indicia of the presence of chlorine.

16. The article according to claim 15, wherein the chlorine indicating component comprises at least one of an iodide salt or a bromide salt.

17. The article according to claim 16, wherein the iodide salt comprises at least one of potassium iodide, sodium iodide, or calcium iodide, and wherein the bromide salt comprises at least one of potassium bromide, sodium bromide, or calcium bromide.

18. The article according to claim 15, wherein the substrate comprises a metal.

19. The article according to claim 15, wherein the article is a storage container for storing chlorine.

20. The article according to claim 15, wherein the article is a railcar for storing and transporting chlorine.
